(19) United States
(12) Patent Application Publication
(10) Pub. No.: US 2005/0133400 A1
(43) Pub. Date: Jun. 23, 2005

(54) Food preservation device

(76) Inventor: Edward Anton Stigler, Inverness, FL (US)

Correspondence Address: EDWARD ANTON STIGLER, 182 N. GOLF HARBOR PATH, INVERNESS, FL, 34450, US

(21) Appl. No.: 10/740,097

(22) Filed: Dec. 18, 2003

(51) Int. Cl. A23L 1/00

(52) U.S. Cl. 206/564

(57) ABSTRACT

A preservation device provides a simple, inexpensive, sanitary, and effective means to preserve a food product, more particularly a cheese product. The device includes four sides and an end to fit over the exposed end of the food or cheese product, there by sealing the product and extending the shelf life and quality of the food or cheese product. A variety of shapes and sizes are provided to correspond to a variety of shapes of food products.

The present invention relates to a food preservation device, and more particularly a cheese preservation device that preserves and maintains the freshness and quality of cheese products from drying out once the cheese product has been opened.

This invention relates to an improved device and method for preserving and maintaining the freshness and quality of prepared cheese products. In commercial production of prepared cheese products, a variety of sizes and shapes of finished products are over wrapped in foil, polyethylene, waxed paper, plastic or paper, and then may be packed in cardboard packages. These packages are shipped to retail establishments for sale to the public.

When the packaged cheese product is utilized by the consumer, the over wrap film, paper, or the predominately used foil is torn, cut, ripped or pealed away from the prepared cheese product. A certain amount of cheese is removed for consumption and the remaining cheese is re-wrapped by crushing, folding or squeezing the over wrap around the cheese product. These various methods to protect the quality of the remaining cheese product allow air to enter the package, which is detrimental to the cheese product.

The appearance and overall quality of the unused portion of cheese product suffers as oxidation takes place and the cheese product darkens, dries out, develops mold, and in general renders a considerable amount of the cheese product to be inedible. The result of this type of closure of the over wrap causes an amount of the cheese product to be discarded and a loss to the consumer of expected usable product occurs.

Accordingly, the present invention is directed to a food preservation device that substantially obviates one or more of the problems and disadvantages in the prior art. Additional features and advantages of the invention will be set forth in the description that follows, and in part will be apparent from the description, or may be learned by practice of the invention. The objectives and other advantages of the invention will be realized and attained by the apparatus and process particularly pointed out in the written description and claims, as well as the appended drawings.

### SUMMARY OF THE INVENTION

To achieve these and other advantages and in accordance with the purpose of the invention as embodied and broadly described herein, the invention is directed to a food preservation device to reduce the aging process of a food product including four side walls, each of the four side walls disposed in a generally orthogonal relationship to an adjacent one of the side walls, and a end cap adjacent at least one end of each of the four side walls to close at least one end of the device.

In another aspect, the invention is directed to a method for preserving a food product having an over wrap, the method includes providing a food preservation device to reduce the aging process of a food product comprising four side walls, each of the four side walls disposed in a generally orthogonal relationship to an adjacent one of the side walls and an end cap adjacent at least one end of each of the four side walls to close at least one end of the device, exposing an end of the food product by removing at least a portion of the over wrap, and disposing the food preservation device on the exposed end of the food product to cover the exposed end.

It is to be understood that the foregoing general description and the following detailed description are exemplary and explanatory and are intended to provide further explanation of the invention as claimed.

The accompanying drawings are included to provide a further understanding of the invention and are incorporated in and constitute a part of the specification. The drawings illustrate several embodiments of the invention and together with the description serve to explain the principles of the invention.

### BRIEF DESCRIPTION OF THE DRAWINGS

FIG. 1 is a perspective view of one embodiment of a food preservation device according to the present invention;

FIG. 2 is a perspective view of another embodiment of a food preservation device according to the present invention;

FIG. 3 is a perspective view of another embodiment of a food preservation device according to the present invention;

FIG. 4 is a perspective view of another embodiment of a food preservation device according to the present invention; and

FIGS. 5A-5E illustrate the use of a food preservation device with a food product according to the present invention

### DETAILED DESCRIPTION OF THE INVENTION

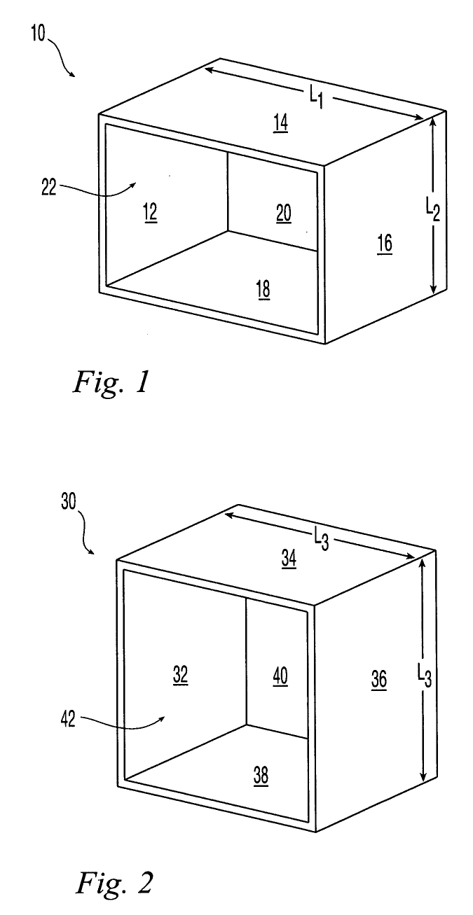

As shown in FIGS. 1-4, the present invention is a one-piece open-ended cube, square, rectangular, cylindrical, or triangular container having the dimensions of the most commonly available commercial prepared cheese food products. As shown in the embodiment illustrated in FIG. 1, the food preservation device 10 is generally rectangularly shaped having four walls 12,14,16,18 that are generally orthogonal to an adjacent wall. The device 10 has one closed end 20, and an open end 22 to receive the cheese or other food product. In device 10, the opposite walls 14,18 have a first length L₁ and walls 12,16 have a second length L₂, and L₁ is greater than L₂. This embodiment would be best used with an 8 oz commercially available cheese product as it has about the same dimensions. Preferably, L₁ is about 2″ and L₂ is about 1⅜″, although other values are acceptable as can be seen in the other figures. For example, FIG. 2 illustrates another embodiment of a food preservation device 30 that is generally square in cross section and corresponds to a 10 oz cheese product. Walls 32,34,36,38 are all about the same length L₃, which is preferably about 1½″, but could be of any appropriate size for the food product on which it is to be used. Again, food preservation device 30 has one closed end 40, and an open end 42 to receive the cheese or food product.

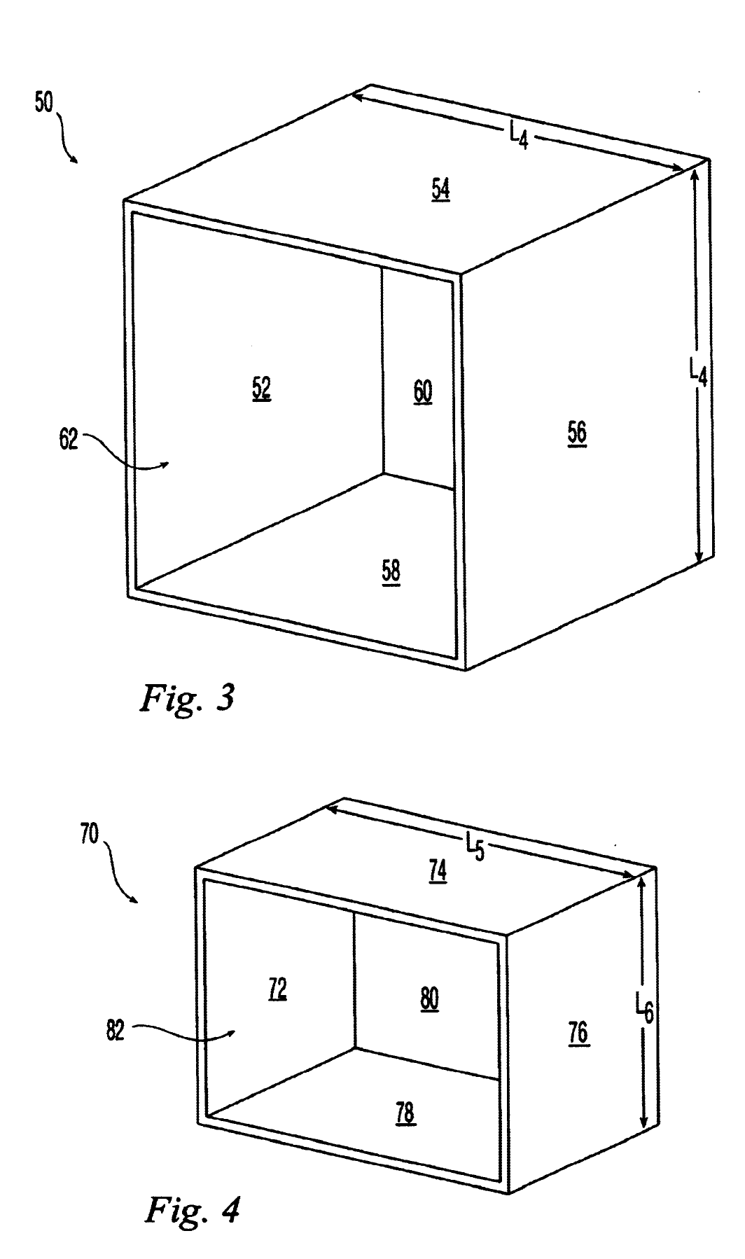

FIG. 3 illustrates a larger food preservation device 50 to be used with a 2 lb. cheese product. The walls 52,54,56,58 are again about the same length, L₄, which is about 2½″, again other dimensions are possible. The food preservation device 50 also has a closed end 60 and an open end 62 to receive the food or cheese product.

Finally, FIG. 4 illustrates another embodiment of a food preservation device 70, which can be used with a 16 oz. cheese product. As with the embodiment in FIG. 1, the opposite walls 74,78 have a first length L₅ and walls 72,76 have a second length L₆, and L₅ is greater than L₆ In this embodiment, the length L₅ is preferably about 2¼″ and length L₆ is preferably about 1⅝″. The food preservation device 70 also has a closed end 80 and an open end 82 to receive the food or cheese product. The preferably depth of all of the food preservation devices 10,30,50,70 is about 1½″, but could be any appropriate distance. Moreover, the walls of all devices are preferably 1/16 of an inch thick, but could be thinner or thicker depending on the application.

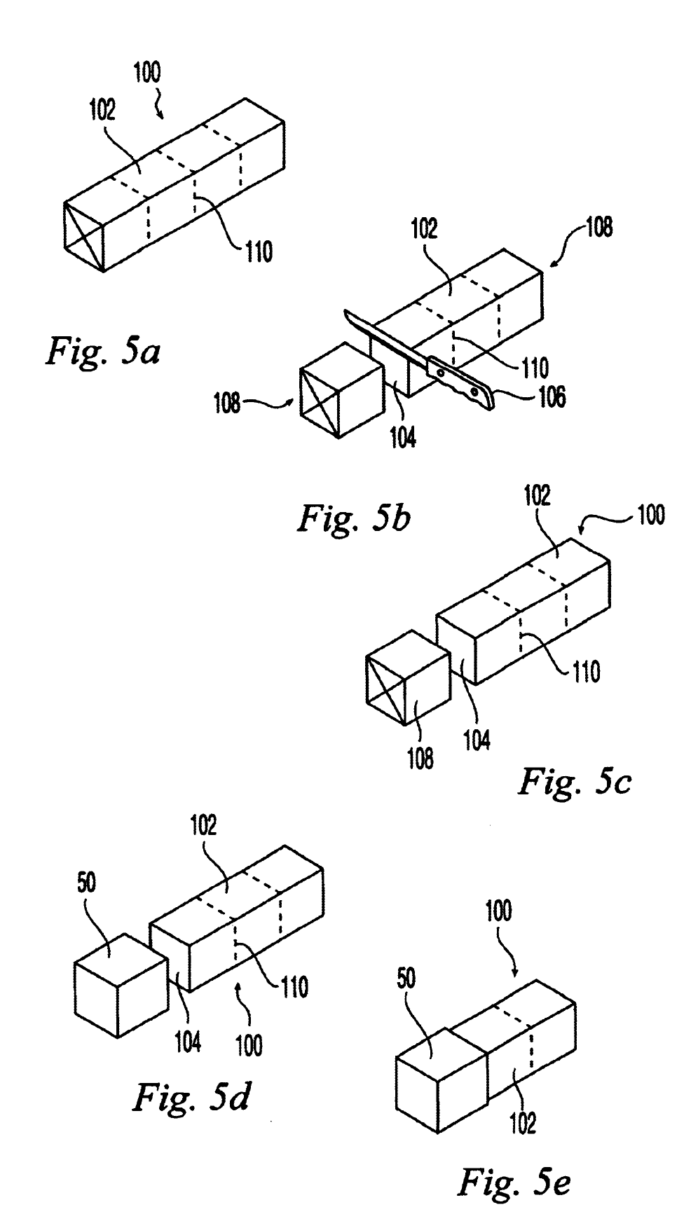

As illustrated with reference to FIGS. 5a-5e, the open-ended device is used as a cover or sleeve, which is placed over the exposed, or cut end of the prepared cheese product after the cheese product over wrap is opened. An example of a cheese product 100 is illustrated in FIG. 5a. The container forms a seal around the edges of the over wrap 102 of the cheese product 100 and against the exposed surface 104 of the prepared cheese product 100. As shown in FIG. 5B, a user would use knife 106 to cut through the wrap 102 and product 100, exposing an end 104 of the cheese product. The portion 108 of cheese product to be used is removed in FIG. 5C. The food preserving device 50 is introduced in FIG. 5D to seal the end of the cheese product 100. (Device 50 is illustrated as the cheese product illustrated is the 2 lb product making the device 50 the best fit as discussed above. However, the FIGS. 5a-5e applies to the other devices as well.) This seal is accomplished by leaving an amount of the over wrap material 102 on the prepared cheese product 100, and binding the over wrap 102 with the device 50 to prevent exposure to air. The device can be made of plastic, glass, foil, metal, or paper. However plastic is the ideal material. Plastic is the preferred choice because of the ease of manufacturing, it is a lightweight material, allows the user to see the product (i.e., has visual clarity), is easy to clean to provide sanitary handling.

Further, many of the commercial brick prepared cheese products have printed marks 110 on the foil over wrap 102. These marks 110 are suggested indicators for cutting the cheese brick into approximate weight proportions, and can be used to make a clean cut through the foil over wrap 102. Cutting of the over wrap rather than tearing or ripping facilitates the placement of this invention over the remainder of the prepared cheese product quite easily. An embedded tear type-opening strip at each of the suggested portion control marks would greatly facilitate a clean-cut edge to the over wrap and enable a very good seal to the remaining prepared cheese product when utilizing the article of this invention. The triangular and cylindrical containers (not shown) can be any triangular or cylindrical size with an overall length of 1½ inches.

Shelf Life Testing

Commercially prepared cheese products (Kraft Velveeta prepared cheese product; Net weight 32 oz (2 lb) 907 g Kraft Foods NA, Inc.) were tested in two distinct procedures. The results of these tests are as follows:

| Visual | Outer package opened | Outer Package Opened, and |
|---|---|---|
| Condition | and refolded. No other | sealed with article of this |
| After: | protection used | invention, a plastic cube |
| 24 hours | darkening at center of | no sign of change in quality |
| | cheese | no sign of change in quality |
| 48 hours | slightly more darkening | or appearance |
| 3 days | heavy dark streak | no sign of change in quality |
| | | or appearance |
| 5 days | heavy dark streak- | no change in quality or |
| | hardening of edges | appearance |
| 1 week | discolored, streaks and | no change in quality - soft |
| | hard edges | texture excellent color |
| 2 weeks | very hard streaks - hard | excellent quality retention - |
| | edges and center - dark | no change noted - entire |
| | surface in center and | cheese brick remains edible - |
| | approximately 10% inedible | cheese color very bright |
| 3 weeks | white mold spots on cheese | no change in color or quality - |
| | surface, hard corners and | cheese surface is soft, moist |
| | darkened | and clear - no discoloration |

Test samples were refrigerated at all times during testing and stored at refrigeration temperature of 38 degrees “F.”. Test was terminated after 3 weeks of storage.

It will be apparent to those skilled in the art that various modifications and variations can be made in the multi-fiber ferrule of the present invention without departing from the spirit or scope of the invention. Thus, it is intended that the present invention cover the modifications and variations of this invention provided they come within the scope of the appended claims and their equivalents.

1-7. (canceled)

8. A food preservation device to reduce the aging process of a food product comprising:
four side walls, each of the four side walls disposed in a generally orthogonal relationship to an adjacent one of the side walls; and
an end cap adjacent at least one end of each of the four side walls to close at least one end of the device.

9. The food preservation device according to claim 8, wherein a first set of two opposed side walls and a second set of two opposed side walls have different lengths.

10. The food preservation device according to claim 8, wherein the food preservation device has a square cross sectional shape.

11. The food preservation device according to claim 8, wherein the food preservation device has a rectangular cross sectional shape.

12. The food preservation device according to claim 8, wherein the food preservation device is made of plastic.

13. The food preservation device according to claim 8, wherein the food preservation device is disposed on an open end of a food product.

14. A method for preserving a food product having an over wrap, the method including the steps of:
providing a food preservation device to reduce the aging process of a food product comprising four side walls, each of the four side walls disposed in a generally orthogonal relationship to an adjacent one of the side walls and an end cap adjacent at least one end of each of the four side walls to close at least one end of the device;
exposing an end of the food product by removing at least a portion of the over wrap;
disposing the food preservation device on the exposed end of the food product to cover the exposed end.

15. The method of preserving a food product according to claim 14, wherein the step of exposing an end of the food product includes the step of cutting through the over wrap and food product to expose only one surface of the food product.
